(19) United States
(12) Patent Application Publication
(10) Pub. No.: US 2017/0186031 A1
(43) Pub. Date: Jun. 29, 2017

(54) ADVERTISING INVENTORY OPTIMIZATION VIA IDENTIFICATION OF AUDIENCE SEGMENTS

(71) Applicant: Facebook, Inc., Menlo Park, CA (US)

(72) Inventors: Rituraj Kirti, Los Altos, CA (US); Leon R. Cho, Santa Clara, CA (US); Yuval Israel Oren, Pacifica, CA (US); Ying Qin, Saratoga, CA (US)

(21) Appl. No.: 14/983,432

(22) Filed: Dec. 29, 2015

(51) Int. Cl. G06Q 30/02

(52) U.S. Cl. CPC G06Q 30/0246; G06Q 30/0277; G06Q 30/0244; G06Q 50/01

(57) ABSTRACT

An online advertising system evaluates advertising opportunities for online advertising publishers. The online advertising system tracks online users via various tracking methods to receive advertising data and user information for the online users. The online advertising system identifies and segments the online users based on segmenting criteria that are associated with some interest topics (e.g., demographical information). The system calculates projected advertising revenue for each audience segment and generates an inventory optimization dashboard based on the calculated revenue. The inventory optimization dashboard helps the advertising publishers better understand the online advertising traffic and better optimize their advertising inventory. For example, the advertising publishers may advertise to specific audience segments which tend to purchase the advertised products or services.

### BACKGROUND

This disclosure relates generally to online advertising, and more specifically to evaluating advertising opportunities associated with different audience segments for online advertising publishers.

Online advertising (ad) publishers generate advertising revenue by charging advertisers for displaying advertisements submitted by the advertisers to users that visit the advertising publishers. However, online advertising publishers may receive advertising requests from various types of user devices, such as desktops and mobile devices, which may cause difficulties in targeting segments of a publisher's audience that are most likely to purchase the products and/or services advertised by the advertisements. Additionally, it may be difficult for the advertising publisher to identify how to better provide advertisements, resulting from an inadequate understanding of the audience segments such as the behaviors, interests and demographic information of the audience to whom the publishers are displaying advertisements. Additionally, some online publishers fail to consider the actual advertising price and advertising demand for different segments. For example, even if the publishers know a lot about personal interests of an audience segment for the advertised products, the publishers still cannot confirm whether that segment generates significant revenue compared with other audience segments.

### SUMMARY

An online advertising system is designed to help advertising publishers to evaluate advertising opportunities for different segments of audiences associated with different interest topics to optimize their advertising inventory. The advertising inventory represents the opportunities for advertisers to present advertisements to users, for example, a slot or space in a page accessed by a user on an ad publisher's webpage. Thus, the advertising inventory includes opportunities to provide an advertisement to the various users accessing the ad publisher, forming an audience of the ad publisher. The advertising system tracks users of the advertising system via different tracking methods to receive advertising impression data and user data about the tracked audience associated with the advertisements displayed to them. The advertisements are provided by advertising publishers, advertisers, social networking systems, and other data providers. The advertising system identifies and groups the tracked audience into different segments based on the received data and data extracted from user databases of a social networking system. The received and extracted data may include information about users such as age, gender, hobbies and purchasing intentions on specific products and/or services.

The advertising system further gathers data about advertising statistics such as advertising price and advertising demand for the segmented audience. These advertising statistics may be determined from advertisements provided by the advertising system itself to various publishers, or may be determined from reports by ad publishers for completed advertising auctions. The advertising price indicates the price ad publishers can charge the advertisers to generate advertising revenue and the advertising demand indicates the demand from advertisers to target individual identified advertising segments. The advertising system uses a revenue calculation model to calculate projected advertising revenue for each audience segment based on all the received data such as advertising impression data, user data and advertising statistics. For a publisher to evaluate the value of advertising to visitors of its webpage using segmenting, the publisher directs its visitors to the advertising system, which identifies which segment the user belongs to, and determines the number of users in each segment that visit the publisher. The advertising system applies the revenue calculation model for the publisher to determine the value for the advertiser of each segment. The revenue calculation model determines a projected revenue, for example, by determining the number of users in an audience segment, advertising demand for advertising to that segment, and estimated revenue per impression. This projected revenue may be adjusted by a publisher's current site-wide CPM, which may also be adjusted for a particular advertising format, to account for improved or reduced site-wide revenue of the publisher relative to the advertising system. An inventory optimization dashboard is generated by the advertising system to present to the publisher the projected advertising revenue for each audience segment to help the publisher optimize its inventory and assess the value of identifying the characteristics and relevant segment of the audience of the publisher.

### BRIEF DESCRIPTION OF THE DRAWINGS

FIG. 1 (FIG. 1) is a high-level block diagram of a system environment for an advertising system that identifies audience segments to help online publishers optimize advertising inventory, according to one embodiment.

FIG. 2 is an example block diagram of the architecture of the advertising system, according to one embodiment.

FIG. 3 is a flowchart illustrating a process of generating an inventory optimization dashboard, according to one embodiment.

FIG. 4 is an example inventory optimization dashboard for online publishers, according to one embodiment.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED FIGURE DESCRIPTION

One embodiment of a disclosed configuration is a system (or a computer implemented method or a non-transitory computer readable medium) for evaluating advertising opportunities and predicting advertising revenue associated with different audience segments for online advertising publishers. Online audiences for a publisher are identified and grouped in different segments based on a variety of personal information such as age, gender, demographic information, personal interest and online behavior. The different audience segments are evaluated and ranked to determine an inventory optimization dashboard that shows the ranked projected advertising revenue that is or could be generated by offering advertisements to the audience by identifying segment data for users when advertising. The online publishers may repackage their advertising inventory to generate more revenue from online advertising traffic based on information from the inventory optimization dashboard. The online publishers may use the advertising system to evaluate the efficacy of current advertising, to request segment data from the advertising system for visitors of the online publisher, or to request the advertising system to provide advertisements for the visitors of the online publisher.

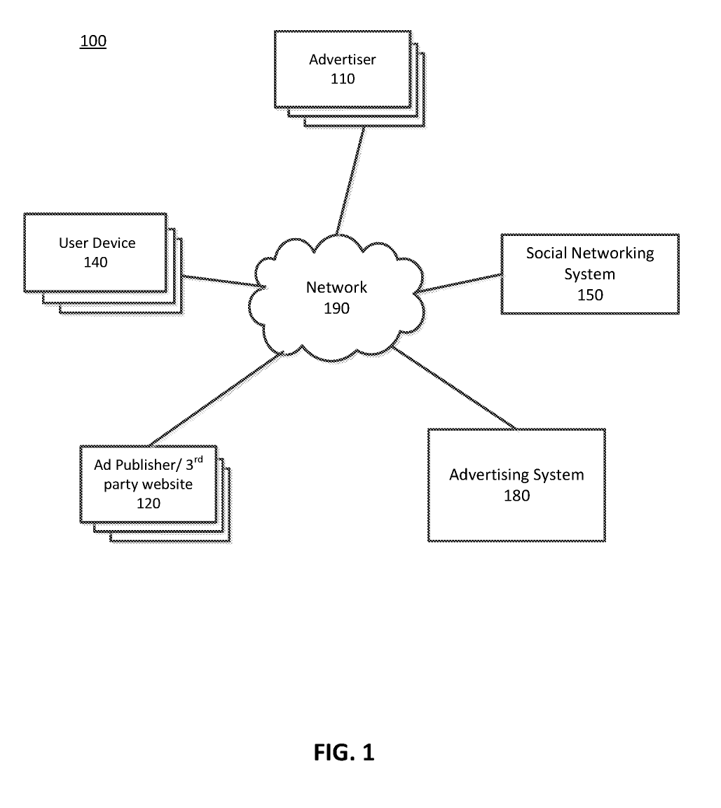

FIG. 1 is a high-level block diagram of a system environment 100 for an advertising system 180 that identifies audience segments for advertising inventory, according to one embodiment. In the embodiment of FIG. 1, the system environment 100 includes one or more advertisers 110, one or more advertising publishers or third party data providers 120, one or more user devices 140, a social networking system 150, an advertising system 180 and a network 190. In alternative configurations, additional or fewer components may be included in the system environment. Likewise, the functions performed by the various entities of FIG. 1 may differ in different embodiments. For example, in some embodiments the advertising system 180 is integrated into the social networking system 150 or as a part of one of the ad publishers 120.

As more fully described below, the advertising system 180 receives audience data and advertising (ad) impression data from advertising publishers 120. The advertising system 180 identifies audiences of the various ad publishers 120 and further segments the audiences based on the advertising impression data and audience data received from publishers 120 and user data from the social networking system 150. For an individual publisher 120, the advertising system 180 evaluates potential advertising revenue associated with each audience segment visiting that publisher 120 and generates an evaluation result, for example, an inventory optimization dashboard for the online publisher 120.

The advertising system 180 is an advertising platform that selects advertisements submitted by advertisers 110 and places the selected advertisements in advertising slots for presentation to users on user devices 140. The advertising system 180 selects advertisements from these advertisers 110 and decide which advertisements to display to online users and which advertisers to charge for presentation of the advertisements. In one embodiment, the advertising system 180 charges advertisers 110 different advertising prices for advertisements filling ad slots that have different places or for advertisements that have different content and the content may represent different advertised products and/or services. The advertising system 180 may provide advertisements for slots on a webpage of advertising publishers 120, and generate advertising data representing the results of placing the advertisements to different users. The advertising system 180 may also receive advertising data from other advertisement selection systems or processes. For example, an ad publisher 120 may use an alternate system for selecting and providing ads to users, or may select and provide ads itself.

Example advertising publishers 120 include search engines, social networking systems, news distribution systems, online forums and any other electronic system or webpage hosting platform that provides content and advertisements to users. Users access their user devices 140 to navigate online content provided by the online publishers 120. As one example, an advertising publisher 120 is a search engine that fills advertising slots on the webpage of the search engine with selected advertisements for users to view.

A user device 140 is a computing device that is capable of receiving user input as well as of transmitting and/or receiving online data via the network 190. In the embodiment shown by FIG. 1, one or more user devices 140 can communicate within the network 190 and interact with the advertising publishers 120 to receive and download content from the publishers. The user device 140 may also access the advertising system 180 for an advertisement. For example, a user device 140 may request a webpage of an advertising publisher 120 that includes a reference to the advertising system 180. As further described below, the advertising publisher 120 may also include a tracking pixel or other reference to the advertising system 180 without including a request for advertisements for the user device 140. The user devices 140 also interact with the advertising system 180 to provide user data to or to receive information from the advertising system 180. In one embodiment, a user device 140 can be a conventional computer system, such as a desktop or a laptop computer. In another embodiment, a user device 140 can be a mobile telephone, a smartphone or a personal digital assistant (PDA). In one embodiment, the user device 140 interacts with other components in the network 100 through an application programming interface (API) running on an operating system of the user device 140.

The network 190 shown in FIG. 1 may comprise any combination of local area and wide area networks, using wired or wireless communication systems. In one embodiment, the network 190 uses standard communications technologies and/or protocols such as Ethernet, 802.11, worldwide interoperability for microwave access (WiMAX), 3G, 4G, code division multiple access (CDMA), etc. Example communication protocols include transmission control protocol/Internet protocol (TCP/IP), hypertext transport protocol (HTTP), file transfer protocol (FTP) and multiprotocol label switching (MPLS). Data exchanged over the network 190 can be represented for example, in the format of hypertext markup language (HTML) or extensible markup language (XML). Additional technologies may also be used in the network 190.

The social networking system 150 shown in FIG. 1 is configured to provide user data to identify online audience for the advertising system 180. The social networking system 150 has a large user database that stores user data of its registered users. In one embodiment, example user data include profile information provided by users on profile pages such as name, age, gender, email address, mobile contact information, education history, work experience and etc. In another embodiment, user data stored in the user database in the social networking system 150 can be analyzed data such as personal hobbies and purchasing intentions on specific products or service. The analyzed data can be acquired by tracking user behavior on the social networking system 150 or by other identification methods. The user data is provided to the advertising system 180 to identify the online audience and to further group the identified audience into different segments.

The advertising system 180 receives information about users accessing various ad publishers 120 to identify users or user devices 140. In one embodiment, the advertising system 180 uses different tracking methods such as tracking pixels and tracking tags to track online behavior of the audience (generally referred to as a tracking pixel). In one embodiment, the advertising system 180 uses a tracking pixel, for example, a tracking pixel associated with a log-in to the social networking system 150, or a tracking pixel unique to the advertising system 180. The tracking pixel may be used to direct the user to the advertising system 180 to identify user behavior across many ad publishers. The tracking pixel is used to track online audience to receive updated information like advertising impression data associated with users who view or interact with the displayed advertisements and to further receive updated data as users access additional content.

Different online publishers 120 may put different kinds of tracking pixels or tags into their different webpages to track various information related to the online publishers 120. To implement the tracking pixel, the publisher 120 may add pixel code in a portion of the publisher's webpage directing the user device to access the advertising system 180. As one example, a publisher 120 may insert the pixel code into the header file of all of its website pages and user devices 140 that access that those pages are directed to the advertising system 180. As another example, for users who search for a product on the website of a publisher 120, the publisher may add the pixel on the header file of the webpage that shows search results. For users who view the detailed information of a specific product, the publisher 120 may add the pixel on the header file of the webpage that shows the details of that product. For users who may start purchasing and intend to pay for the items they want to purchase, the publisher 120 may add the pixel on the “Add to Cart” or “Checkout” webpage. The pixel code may also add data to the reference to the ad publisher 120 to indicate information about the page or the user. The data that has been passed into the tracking pixel can vary according to different tracking purposes. The data may include an identification of the page referring the user (i.e., a URL or other resource locator) and may include information about the content of the page. For example, for a product on the website of an online publisher 120, the data passed to the tracking pixel may include information about category, size, color and other information about the product. The websites where tracking pixels are placed can be websites accessed by various user devices, such as desktops, laptops and mobile telephones. The advertising system 180 receives a variety of advertising impression data and audience data from the online data tracked by the tracking pixels and the data received reflects information like online behavior of the audience the advertising system 180 has reached.

The advertising impression data may include the number of impressions for a specific advertisement displayed on the user devices 140. The advertising impression data may also include publisher information that identifies the advertising publisher 120 that is providing the page for the advertisement and advertiser information that identifies the advertiser 110 that submits the selected advertisement to the publisher. Online user data received by the advertising system 180 is combined with user data extracted from the social networking system 150 and from other data providers to identify the online audience viewing or interacting with the displayed advertisements. Example data providers can include one or more advertisers 110, one or more advertising publishers 120 and other third-party databases that collect and store online user data.

After receiving the ad request from the user device 140 and identifying the user associated with the request, the advertising system 180 groups the identified users into different segments. The criteria for segmenting the identified audience can vary based on the user data and other advertising statistics received by the advertising system 180 as described below. Example advertising statistics include advertising pricing data such as Cost per Thousand Impressions (CPM), Cost per Impression (CPI), Cost per Click (CPI) and advertising demand data. In one embodiment, when the advertising system 180 displays the advertisements submitted by the advertisers 110, the advertisers pay for the publishers in different ways of payment such as CPM, CPI and CPC and the publishers generate advertising revenue in this way. The advertisers 110 may pay with different CPMs for the same advertisements displayed on different advertising publishers 120. The advertising demand data indicates the advertising demand for specific audience segments. The advertising demand data can be generated by the advertising system 180, or provided by advertisers 110, the social networking system 150 or other data providers that collect and store data about online advertising traffic.

The advertising system 180 evaluates the advertising statistics for the segmented audience to generate an evaluation result that recommends the relative value of advertising to the audience segments for ad publishers 120. In one embodiment, an inventory optimization dashboard is generated for presentation to online publishers 120 to show the evaluation result.

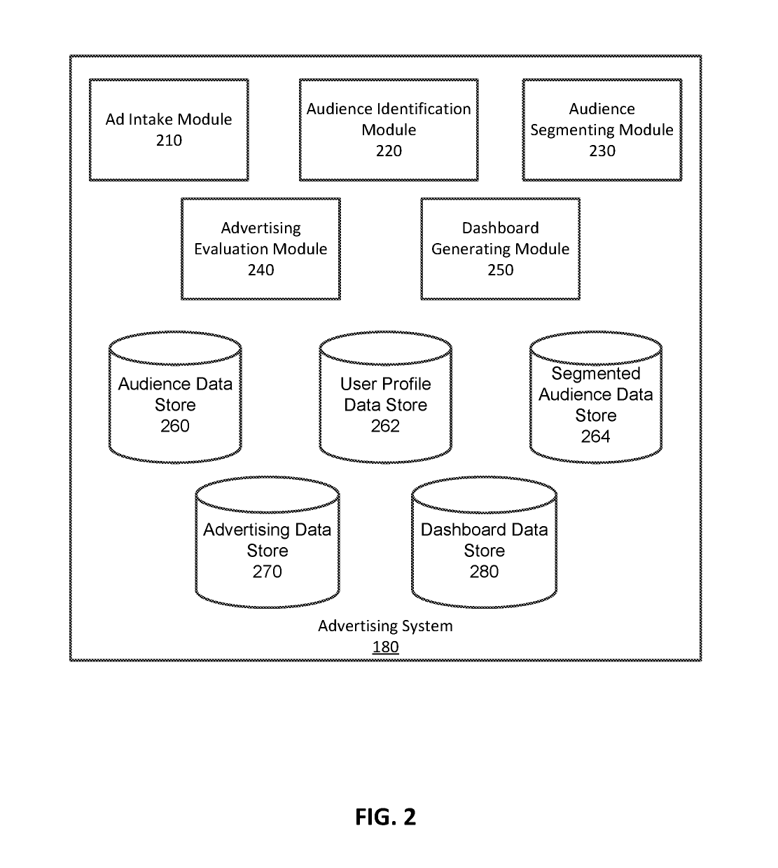

FIG. 2 is a block diagram of the architecture of the advertising system 180, according to one embodiment. In the embodiment of FIG. 2, the advertising system 180 includes an audience data store 260, a user profile data store 262, a segmented audience data store 264, an advertising data store 270, a dashboard data store 280, an advertising (ad) intake module 210, an audience identification module 220, an audience segmenting module 230, an advertising evaluation module 240 and a dashboard generating module 250. In alternative embodiments, additional or fewer components can be included in the advertising system 180. Likewise, the functions described below of the components may be distributed among components in the advertising system 180 in a different way than is described here.

The audience data store 260 stores audience data received by the ad intake module 210. Example audience data include audience identifiers that identify unique users such as name, email address, usernames or user accounts for one or more social networking systems. The audience data may also include online behavior data of a specific user, and may not individually identify users. Example online behavior data may include online shopping records, viewing history for specific interest topics like advertised products or services. The audience data stored in the audience data store 260 is used by the audience identification module 220 to identify the users accessing the advertising system 180 (e.g., through a tracking pixel on an ad publisher) and for the audience segmenting module 230 to segment the identified users.

The user profile data store 262 stores data extracted from user databases in the social networking system 150 and may include independently-generated profile data for users. The advertising system 180 may also incorporate a social networking system 150 and request user data from the social networking system that is part of the advertising system. In one embodiment, the user data stored in the user profile data store 262 may include user information such as name, age, gender, hobbies, education history and work history which are provided by a user of the social networking system 150. The user information may be displayed on the social networking system 150 for public view or with some privacy view settings and the private view settings allow only certain groups of users to view the user information provided by that user. In another embodiment, the user data stored in the user profile data store 262 may include independently-generated data or analyzed user data generated by the social networking system 150 to acquire a deeper understanding of its users. In one embodiment, the analyzed user data may be more accurate compared with user information directly and actively provided by the users for presentation on the social networking system 150. The analyzed user data may also include user information that indicates users' interest for specific topics such as interest on specific brands and purchasing intentions for specific products or service. Example analyzing methods may include machine learning technologies that train and test a large volume of user data to determine personal interests of a user. Other behavior analysis methods may also be used by the social networking system 150 to generate analyzed data. The data stored in the user profile data store 262 is used by audience identification module 220 to identify online users and the audience segmenting module 230 to segment identified users.

The segmented audience data store 264 stores data about segmented audience that is generated by the audience segmenting module 230. Each audience segment is associated with a group of audience segmented by a segmenting criterion designating different types of audience segments. Each user or accessing user device 140 may be identified as belonging to one or more audience segments. In one embodiment, a segmenting criterion is associated with a specific topic such as an interest topic or a purchasing intention on specific products and/or services. The segmenting criterion may also specify demographical information such as age, gender, or geographical location. Different kinds of segmenting criteria may be used by the audience segmenting module 230 to segment identified users. In one embodiment, different audience segments stored in the audience data store 264 may be independent with each other without any overlap based on one single segmenting criterion. For example, based on an age segmenting criterion that segments audience by age, one audience segment may be a millennials segment that represents a population generation who were born between 1980s and early 2000s. Another segment based on this segmenting criterion can be a senior segment which represents a population generation born before 1950s. In another embodiment, a plurality of audience segments stored in the segmented audience data store 264 may overlap with each other and these audience segments are segmented based on different segmenting criteria. For example, one audience segment can be a millennials segment based on an age segmenting criterion and another audience segment can be a fruit buyer segment based on a segmenting criterion associated with a fruit purchasing interest. Some of the members in the millennials segment may also be the members in the fruit buyer segment, which indicates an overlap between these two audience segments. The audience segment data stored in the segmented audience data store 264 is used for other modules such as advertising evaluation module 240 and dashboard generating module 250.

The advertising data store 270 stores both ad impression data received by the ad intake module 210 and advertising statistics received from online publishers 120, advertisers 110, the social networking system 150, other data providers and acquired by the advertising system 180 itself. The advertising statics include ad pricing statistics and advertising demand data for the various audience segments. In one embodiment, example ad pricing statistics include CPI and CPM for specific advertisements submitted by specific advertisers 110 as described above. In another embodiment, the advertising system 180 or social networking system 150 also selects advertisements submitted by advertisers 110 and displays the selected advertisements to its users and the different advertisements submitted by different advertisers also have different CPMs which are stored in the advertising data store 270. Advertising demand data indicates the advertising demand for each of the various audience segments by advertisers 110. In one embodiment, the advertising demand may indicate how many identified users in an audience segment have a strong intention to actually buy the advertised products instead of only viewing or clicking on the advertisement pages. The advertising demand data can also indicate how many identified users are already targeted by the advertisers 110. The advertising demand data can be provided by advertisers 110, advertising publishers 120, the social networking system 150 and other data providers that collect and store statistics indicating the actual purchasing intentions and demands of online audience. The advertising statistics stored in the advertising data store 270 is used by the advertising evaluation module 240 to generate advertising evaluation results.

The dashboard data store 280 stores dashboard data that is generated by the advertising evaluation module 240. In one embodiment, example dashboard data includes information about different audience segments such as segment names and segmenting criteria. The dashboard data may also include information about the number of advertising impressions and unique impressions, projected CPM, popularity, advertising demand, projected advertising revenue, and projected rank for different audience segments. The projected CPM is calculated by the advertising evaluation module 240 to indicate a projected spending by the advertisers 110 on advertising their products and a corresponding projected revenue received by the publishers 120 for charging the selected advertisers with displaying their advertisements. The projected advertising revenue is also calculated by advertising evaluation module 240 to indicate the predicted revenue a publisher 120 can generate from providing online audiences with the selected advertisements submitted by the advertisers 110. In one embodiment, the projected advertising revenue can be calculated based on multiple advertising factors such as ad impressions, CPMs and advertising demand. The popularity indicates the quantity of advertising spend of advertisers relative to the size of the segment. One way to determine the popularity for an audience segment is based on the number of ad impressions and unique impressions of advertisements for the audience segment. The projected rank indicates the ranking of the projected advertising revenue for different audience segments. The audience segments that have higher projected advertising revenue are placed on top positions in the projected ranking. In other embodiments, other ad pricing statistics such as CPC and CPI may also be used to generate corresponding projected CPC and CPI that is stored in the dashboard data store 280. The dashboard data stored in the dashboard data store 280 is configured to be used by the dashboard generating module 250.

The ad intake module 210 is used by the advertising system 180 to receive tracked online data such as ad impression data and audience data generated by the advertising system itself or received from online advertising publishers 120. In one embodiment, the ad intake module 210 may extract ad impression data and audience data from online data tracked by different kinds of tracking pixels, for example when a user device accesses the advertising system 180 from a tracking pixel provided on a page by an ad publisher 120. After the ad intake module 210 receives the data mentioned above, the data is stored in the audience data store 260 and in the advertising data store 270. The ad intake module 210 continues to receive data from publishers 120 via tracking pixels and to update the ad impression data stored in the advertising data store 270 and audience data stored in the audience data store 260 once new data is received.

The audience identification module 220 is used to process the audience data received by the ad intake module 210 and to identify users reached by the advertising system 180. In one embodiment, the audience identification module 220 may identify the users by audience identifiers recorded by the tracking pixels that are used to track the audience reached by the advertising system 180. For example, the personal information stored in viewing history such as the username or account ID of a user in a social networking system 150 may be extracted to identify the user. The audience identification module 220 may interrogate the user device 140 to retrieve a cookie or other unique identifier of the browser or user of the user device to identify the user device across various ad publishers 120 and browsing sessions. The audience identification module 220 may also request other identifying information from the user device 140, depending on the configuration of the user device. For example, the audience identification module 220 may request a device ID or other unique or near-unique identifying information of the user device 140. In other embodiments, the user may be logged in or authenticated by the social networking system 150, or otherwise associated with a cookie or other identifier stored at the user device 140.

Additional information such as shopping records of a user on a shopping website may also be extracted from the recorded online viewing history to provide online shopping data of the user. In another embodiment, user data from user databases in the social networking system 150 may also be used to identify the users of the user devices 140 accessing the advertising system 180 has reached and the user data extracted from the social networking system 150 is stored in the user profile data store 262. User data extracted from the social networking system 150 may also correct user data received from online publishers 120 to make the user data more accurate. Analyzed user data stored in the user profile data store 262 may also provide independent-generated information or analyzed information like hobbies and purchasing intentions to acquire a deeper understanding of the reached audience. When users access the advertising system 180 from a given ad publisher 120, the audience identification module 220 may also record which ad publisher is associated with the access.

After the audience identification module 220 identifies the reached audience, the audience segmenting module 230 groups the identified audience into different segments. In one embodiment, the audience segmenting module 230 may extract different characteristics that identify different groups of audience from the identified audience to segment the audience. The user characteristics may be extracted from the audience data store 260 and the user profile data store 262 to segment the identified audience. For example, the age information of different identified audience may be extracted and a millennials segment may be generated based on the extracted age information. For another example, for the identified audience, the shopping history information and the purchasing intention information may be extracted from the audience data store 260 and the user profile data store 262, and a fruit buyer segment is generated indicating that this segment targets a group of identified audience who show strong purchasing interest on fruit.

In another embodiment, other advanced segmentation tools are used by the audience segmenting module 230 that have critical infrastructure dependencies including the ingestion of data from the social networking system 150 and the development of additional aggregation functions and filters. As described above, different audience segments may or may not overlap with each other, which indicates members in one segment may or may not be members in another segment. In one embodiment, the audience segmenting module 230 may segment the identified audience one time after extracting all the data from the audience data store 260 and from the user profile data store 262. In another embodiment, the audience segmenting module 230 may dynamically segment and update the identified audience and update the segmenting results based on updated segmenting criteria and/or updated data from the audience data sore 260 and from the user profile data store 262.

The advertising evaluation module 240 extracts ad impression data and advertising statistics stored in the advertising data store 270 to evaluate the advertising revenue that may be available to an ad publisher 120 that provides advertisements via the advertising system 180. Thus, the advertising evaluation module 240 permits the evaluation for an ad publisher 120 of the value of identifying user segments, even if the ad publisher does not use the advertising system 180 for serving its advertisements. In another example, the projected advertising revenue that is more fully described below may demonstrate the value of identifying and evaluating audience segments by the advertising system 180, even if the advertising system does not provide the advertisements.

A revenue calculation model is used by the advertising evaluation module 240 to generate for online publishers 120 evaluation results such as projected CPM, projected advertising revenue and popularity for each audience segment as described above. In one embodiment, the number of ad impressions of advertisements for each audience segment is calculated based on the extracted ad impression data. In another embodiment, the number of unique ad impressions is also calculated. The unique ad impressions represent the number of unique users accessing the advertising system 110 for an ad publisher associated with a given segment. The projected CPM reflects the advertising cost that advertisers 110 spend on advertising to each audience segment. In one embodiment, the projected CPM for a specific audience segment is determined by a segment CPM associated with the audience segment. A segment CPM associated with an audience segment is an advertising price that the advertising system 180 determines the advertisers 110 should be charged for displaying their advertisements to this audience segment. In one embodiment, the segment CPM is determined based on the advertising prices the social networking system 150 charged advertisers 110 for displaying their advertisements on the advertising platforms of the social networking system. The segment CPM can be a site-wide CPM of the advertising system 180. The segment CPM can also be a site-wide CPM of the social networking system 150. In alternative embodiments, the projected CPM can be generated in different ways to consider both the CPM of the social networking system 150 and the CPMs used by different publishers 120, which makes the projected CPM reflect a more accurate and effective estimate of advertising spend for advertisements from advertisers 110. For example, the projected CPM for each audience segment is calculated by multiplying the segment CPM and a scaled CPM factor. The scaled CPM factor scales the segment CPM based on a ratio of the site-wide CPM of the publisher 120 for which the report is generated to the site-wide CPM of the advertising system 180. Both the site-wide CPMs for the publisher 120 and for the advertising system 180 are averaged CPMs that consider advertising prices charged by different publishers over the whole advertising market.

The advertising demand data extracted from the advertising data store 270 is also used by the advertising evaluation module 240 to generate an advertising demand factor. In one embodiment, the advertising demand factor indicates how much advertising spending is actually directed towards a segment by the advertisers 110. For example, the advertising demand factor can be generated from the advertising demand data that shows the relative spending of advertisers 110 to target advertisements to that specific segment relative to total advertising spending on all identified segments or on the highest-spending segment. In this case, the advertising demand factor for an audience segment can be calculated by dividing the cost spent on that audience segment by the total cost spent on all identified audience segments. Both costs are spent by the advertisers 110 that advertise their products on ad publishers 120 and the cost mentioned here can be measured by different measurement methods such as CPM, CPI and CPC, but may be normalized to account for actual total spending of advertisers to reach that segment. In this sense, the advertising demand describes the amount of “unmet need” of advertisers 110 to target this segment, which cannot be accounted for by publishers that do not identify or segment users accessing that publisher. In this way, the publisher can promote the value of advertising with the advertising system 180 or receiving user segment data from the advertising system.

After the advertising evaluation module 240 generates for each audience segment, the analyzed advertising statistics such as the number of unique or non-unique ad impressions, projected CPM and the advertising demand factor, the projected advertising revenue for a corresponding audience segment is generated using the revenue calculation model. In one embodiment, the revenue calculation model multiplies these analyzed advertising statistics together to generate the projected advertising revenue for a single audience segment. Thus, one embodiment multiplies the number of unique impressions for a segment with the projected CPM for the segment (as adjusted for that advertiser) and by the advertising demand for that segment. As one example, for an audience segment that identifies avocado buyers, if the number of impressions is 1,000,000, the projected CPM is $50 and the advertising demand factor is 1%, the projected advertising revenue for this avocado buyer segment is $500,000. In this example, the analyzed advertising statistics show that the advertisements advertising avocadoes have a high number of impressions and a high CPM, but a low advertising demand, indicating that although a large number of audience may be interested in avocados and frequently convert or otherwise provide revenue with provided ads, the available advertising revenue for targeting that segment is comparatively low. The projected revenue may be calculated for each segment of users of the advertising system 180, or may be calculated for only certain segments based on an ad publisher's request or capability to solicit advertisers 110 to advertise to that segment.

In alternative embodiments, the number of unique ad impressions as described above instead of the number of ad impressions is used in the revenue calculation model. The revenue calculation model can calculate the advertising statistics to generate projected advertising revenue in alternative ways.

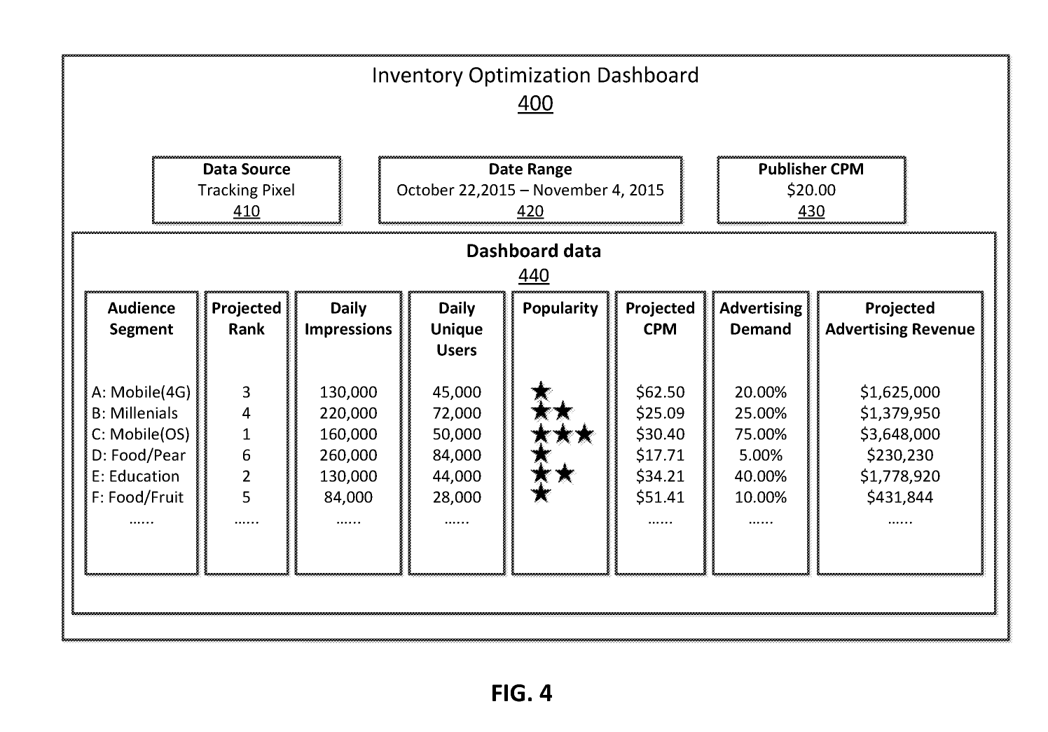

The dashboard generating module 250 is used to generate an inventory optimization dashboard for online publishers 120 and third-party viewers such as advertisers 110 and other data platforms based on the dashboard data stored in the dashboard data store 280. The inventory optimization dashboard is generated to allow the online publishers 120 to see both desktop and mobile advertising traffic and to optimize their advertising inventory to generate more advertising revenue. The information shown in the dashboard may include audience segmentation information, the analyzed advertising statistics such as projected CPM, projected advertising revenue and a projected ranking. An example inventory optimization dashboard is shown in FIG. 4.

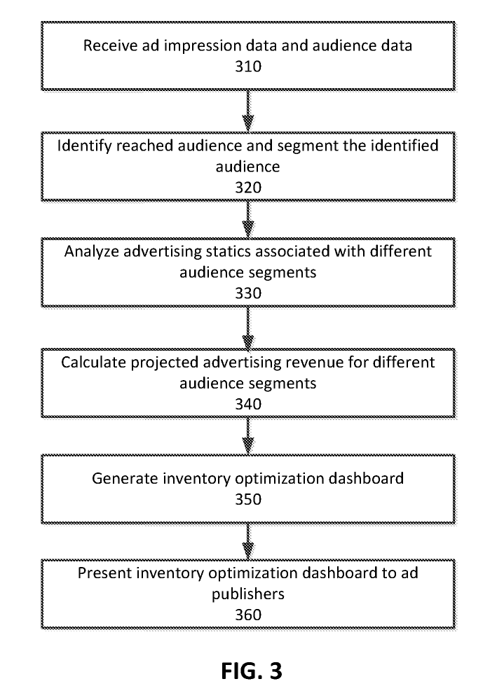

FIG. 3 is a flowchart illustrating a process of generating an inventory optimization dashboard, according to one embodiment. The process shown in FIG. 3 is performed by the advertising system 180 and may use data received from other participants such as online publishers 120, advertisers 110, the social networking system 150 and other third-party data providers.

The advertising system 180 first receives 310 ad impression data and audience data from publishers 120. The advertising system 180 may receive tracking pixels from user devices 140 that receive the advertisements provided by the ad publishers 120, and identify the user based on the tracking pixel and any identifier of the user device, such as a cookie or other data associated with the user device. After the data is received and stored in the advertising system 180, to evaluate the estimated revenue for a given publisher 120, the advertising system then identifies 320 the online audience reached by the advertising system and segments 320 the identified audience into different segments with each audience segment associated with a group of unique audience with a specific topic or characteristic. To identify the online audience, the set of users associated with accesses to the ad publisher 120 are identified from the user identifiers extracted from online tracking data. The advertising system 180 then gathers advertising statistics for each audience segment and analyzes 330 the advertising statistics associated with each audience segment. The advertising statistics may include, for each audience segment, the number of unique or non-unique ad impressions of advertisements, the CPMs used by the advertising system 180, by the social networking system 150, and by different online publishers 120 and the advertising demand data. After processing and analyzing the received advertising statistics, the advertising system 180 calculates 340 a projected advertising revenue for each audience segment. The advertising system 180 then generates 350 an inventory optimization dashboard including the projected advertising revenue and other analyzed advertising statistics for each audience segment. The analyzed advertising statistics may include projected CPM, projected ranking and other statistics for each audience segment. The advertising system 180 presents 350 the generated inventory optimization dashboard to publishers 120 to allow the publishers to view the advertising traffic and to better optimize their advertising inventory. For example, an online publisher 120 may choose advertisements that target an audience segment that ranked top in the projected ranking shown in the dashboard to display to online viewers in order to generate more advertising revenue from the advertising traffic.

FIG. 4 is an example inventory optimization dashboard 400, according to one embodiment. In the embodiment of FIG. 4, the inventory optimization dashboard 400 includes different blocks of information such as data source block 410, date range block 420, Publisher CPM block 430 and a dashboard data block 440. In one embodiment, the data source block 410 indicates the source data for the ad impression data and advertising statistics used to generate the dashboard data. This data may be received from various types of sources, for example from the advertising pixel used by the advertising system 180, or by the social networking system 150 data. For example, the data source shown in FIG. 4 is a tracking pixel, which indicates that the ad impression data, audience data and advertising statistics used to generate the dashboard data is received by using a tracking pixel. In other embodiments, multiple data sources from where the ad impression data and advertising statistics are received can be shown in the data source block 410. The data range block 420 shows the time range during which the advertising statistics, ad impression data and audience data are gathered, analyzed and presented on the inventory optimization dashboard. The Publisher CPM block 430 shows the publisher's designated CPM for its site using advertisements that were not provided by the advertising system 180. This may indicate, for example, the current baseline of advertising sales by the publisher. The dashboard data block 440 shows a variety of dashboard data which are generated by the received advertising statistics and ad impression data for each audience segment. The dashboard data block includes an audience segment block, a daily impressions block, a daily unique users block, a popularity block, a projected CPM block, an advertising demand block and a projected advertising revenue block.

The audience segment block shows information of different audience segments such as name and segmenting criteria for these segments. In the embodiment of FIG. 4, Segment A through Segment F show six different audience segments. In this example, the various audience segments may overlap in users. Thus, in this example, segment B is “millenials” (defining an age range) and segment A is “mobile (4G)” (defining a network connection type). Other segments may define interests, such as segment E for education, or user preferences, such as segment D for fruit. In one embodiment, the different segments are segmented based on a same segmenting criterion and do not have overlap between each other and the sum of every single segment may make up the total audience associated with this segmenting criterion. As one example, the single segmenting criterion used for this inventory optimization dashboard can be based on age range. In another embodiment, the different audience segments shown in audience segment block may have overlap between each other and one or more different segmenting criteria may be used to generate these different segments. In this case, the members in one segment may also be members in another segment. As one example, Segment A may be a millenials segment which represents identified audience born between 1980 and early 2000. Segment B may be a dog food buyer segment which represents identified audience that are interested in buying dog food. Thus, some members in the millennials segment may also be dog food buyers.

The daily impressions block shows information about the number of daily impressions of advertisements accessed by the identified audience in any audience segment listed in the audience segment block. For example, FIG. 4 shows Segment A has 130,000 daily ad impressions associated with the advertisements displayed to audience in Segment A. The daily unique users block shows information about the number of daily unique users associated with the identified audience in any audience segment listed in the audience segment block. For example, FIG. 4 shows Segment A has 45,000 unique daily users associated with this segment.

The popularity block shows the popularity of the segment with advertisers, and reflects advertising demand for that segment, which may be shown in addition to or as an alternative to the projected CPM block and specific advertising demand block.

The projected CPM block shows the statistics about for each audience segment the projected CPM as described above in FIG. 2. For example, among all the audience segments shown in FIG. 4, Segment A has a highest projected CPM which is $62.50 and Segment D has a lowest projected CPM which is $17.71. The advertising demand block shows for each audience segment the advertising demand as described above in FIG. 2. For example, among all the audience segments shown in FIG. 4, Segment C has a highest advertising demand which is 75.00% and Segment D has a lowest advertising demand which is 5.00%. The advertising demand block shown in FIG. 4 indicates that the sum of the advertising demand statistics for every segment is not 100.00%, which further indicates that Segment A through Segment F may not be segmented by a same segmenting criterion and there may be overlap between different segments. A higher percentage of the advertising demand for an audience segment indicates this audience segment has a higher interest from among advertising bids, and represents a larger portion of advertiser spending. For example, Segment D has a relatively high number of daily impressions and a relatively low advertising demand, which indicates that although there are many unique users in Segment D, there is not presently a lot of advertising directed to these users. In contrast, Segment C has a relatively low number of daily impressions and a relatively high advertising demand, which indicates the audience in Segment C is targeted by significantly more advertising than Segment D.

The projected advertising revenue block shows for each audience segment the projected advertising revenue as described above in FIG. 2. The projected advertising revenue indicates a predicted revenue for online publishers 120 that can be generated by charging advertisers 110 to display the advertisers' advertisements to the identified online audience. In one embodiment, the projected advertising revenue is calculated by a revenue calculation model which multiplies the statistics extracted from daily impressions block, projected CPM block and advertising demand block. For example, the projected advertising revenue for Segment C shown in FIG. 4 is $3,648,000 which is calculated by multiplying 160,000, 30.40 and 75.00%.

The projected rank block shows the rank of each audience segment based on the projected advertising revenue. For example, the projected rank shown in FIG. 4 follows a sequence of Segment C, Segment E, Segment A, Segment B, Segment F and Segment D, indicating the sequence of audience segments with projected advertising revenue from high to low.

The dashboard data presented on the inventory optimization dashboard is designed to help online advertising publishers 120 to understand the advertising traffic such as whether identified audience in an audience segment is interested in viewing or interacting the advertisements displayed to them, whether advertisers 110 have a strong intention to place advertisements to that segment and how much revenue an online publisher 120 can generate by advertisements to the identified audience in an audience segment. The inventory optimization dashboard is designed to further help advertising publishers 120 to optimize their advertising inventory after the publishers have a better understanding of the advertising traffic. For example, a publisher 120 may choose to target audiences in an audience segment that can generate the most projected advertising revenue compared with other audience segments presented on the dashboard. The publisher 120 may also choose and charge the advertisers 110 that provide advertisements that most audience are interested to view or interact with. The publisher 120 may also choose and solicit advertisers 110 for segments that have a high CPM, but for which few advertisers have targeted (i.e., have a low advertising demand). Even for ad publishers 120 that do not use the advertising system 180 for its advertisements, by identifying segment information from the advertising system 180 and viewing the efficacy and advertising demand for segments, the ad publishers may improve their ad targeting and solicit advertisers more effectively.

### Additional Configuration Information

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A computer-implemented method comprising:
receiving advertising impression data and audience data, the advertising impression data and the audience data being associated with one or more advertising impression events for one or more advertisements that are provided by a plurality of advertising publishers;
identifying, for an evaluating advertising publisher and based on the received audience data, a set of users that viewed or interacted with the one or more advertisements;
segmenting the set of identified users into one or more audience segments, each audience segment being associated with an interest topic;
determining, for each of the one or more audience segments, advertising statistics;
computing, for the evaluating advertising publisher, projected advertising revenue for each audience segment based on the determined advertising statistics and the received advertising impression data;
generating an inventory optimization dashboard, the inventory optimization dashboard describing the projected advertising revenue for each audience segment, and the inventory optimization dashboard allowing the evaluating advertising publisher to better understand its audience segments for optimizing its advertising inventory to generate more advertising revenue;
presenting the inventory optimization dashboard to the evaluating advertising publisher.

2. The method of claim 1, wherein the plurality of advertising publishers excludes the evaluating advertising publisher.

3. The method of claim 1, wherein receiving the advertising impression data comprises receiving the advertising impression data based on online tracking pixels, and wherein identifying, for an evaluating advertising publisher, a set of users comprises identifying a set of users logged in to a social networking system based on the tracking pixels.

4. The method of claim 1, wherein segmenting the set of identified users into one or more audience segments comprises segmenting the set of identified users based on one or more segmenting criteria, each of the one or more segmenting criteria being associated with an interest topic.

5. The method of claim 4, wherein segmenting the set of identified users into one or more audience segments comprises segmenting at least one of the set of identified users into at least two different audience segments that are based on different segmenting criteria, the at least one user in the at least two audience segments overlapping with each other.

6. The method of claim 1, wherein segmenting the set of identified users comprises segmenting the set of identified users based on user identifiers that identify users associated with different interest topics, the user identifiers being provided by a social networking system.

7. The method of claim 1, wherein the advertising statistics for each audience segment include advertising pricing statistics and advertising demand data for each audience segment, the advertising pricing statistics indicating prices advertisers are charged for displaying the one or more advertisements, the advertising demand data indicating the demand of advertisers to place advertisements to an audience segment.

8. The method of claim 7, wherein the advertising demand data for the audience segment describes spending of advertisers on the audience segment relative to other audience segments.

9. The method of claim 7, wherein the advertising pricing statistics for each audience segment comprises a projected CPM, the projected CPM being calculated by multiplying a segment CPM and a scaled CPM, the segment CPM reflecting the advertising price advertisers are charged for displaying advertisements, the scaled CPM scaling the segment CPM based on a ratio of a site-wide CPM of the evaluating advertising publisher to the segment CPM.

10. The method of claim 1, wherein the projected advertising revenue for each audience segment is determined by, for each audience segment, a multiplication of number of advertising impressions, advertising pricing statistics and advertising demand, the number of advertising impressions being calculated based on the received advertising impression data.

11. The method of claim 1, wherein the inventory optimization dashboard describes information for each audience segment, number of advertising impressions, advertising pricing statistics, advertising demand data, and projected advertising revenue.

12. A system comprising:
a processor configured to execute instructions;
a computer-readable medium containing instructions, the instructions when executed by the processor perform steps:
receiving advertising impression data and audience data, the advertising impression data and the audience data being associated with one or more advertising impression events for one or more advertisements that are provided by a plurality of advertising publishers;
identifying, for an evaluating advertising publisher and based on the received audience data, a set of users that viewed or interacted with the one or more advertisements;
segmenting the set of identified users into one or more audience segments, each audience segment being associated with an interest topic;
determining, for each of the one or more audience segments, advertising statistics;
computing, for the evaluating advertising publisher, projected advertising revenue for each audience segment based on the determined advertising statistics and the received advertising impression data;
generating an inventory optimization dashboard, the inventory optimization dashboard describing the projected advertising revenue for each audience segment, and the inventory optimization dashboard allowing the evaluating advertising publisher to better understand its audience segments for optimizing its advertising inventory to generate more advertising revenue;
presenting the inventory optimization dashboard to the evaluating advertising publisher.

13. The system of claim 12, wherein segmenting the set of identified users into one or more audience segments comprises segmenting the set of identified users based on one or more segmenting criteria, each of the one or more segmenting criteria being associated with an interest topic.

14. The system of claim 13, wherein segmenting the set of identified users into one or more audience segments comprises segmenting at least one of the set of identified users into at least two different audience segments that are based on different segmenting criteria, the at least one user in the at least two audience segments overlapping with each other.

15. The system of claim 12, wherein segmenting the set of identified users comprises segmenting the set of identified users based on user identifiers that identify users associated with different interest topics, the user identifiers being provided by a social networking system.

16. The system of claim 12, wherein the advertising statistics for each audience segment include advertising pricing statistics and advertising demand data for each audience segment, the advertising pricing statistics indicating prices advertisers are charged for displaying the one or more advertisements, the advertising demand data indicating the demand of advertisers to place advertisements to an audience segment.

17. The system of claim 16, wherein the advertising demand data for the audience segment describes spending of advertisers on the audience segment relative to other audience segments.

18. The system of claim 16, wherein the advertising pricing statistics for each audience segment comprises a projected CPM, the projected CPM being calculated by multiplying a segment CPM and a scaled CPM, the segment CPM reflecting the advertising price advertisers are charged for displaying advertisements, the scaled CPM scaling the segment CPM based on a ratio of a site-wide CPM of the evaluating advertising publisher to the segment CPM.

19. The system of claim 12, wherein the projected advertising revenue for each audience segment is determined by, for each audience segment, a multiplication of number of advertising impressions, advertising pricing statistics and advertising demand, the number of advertising impressions being calculated based on the received advertising impression data.

20. The system of claim 12, wherein the inventory optimization dashboard describes information for each audience segment, number of advertising impressions, advertising pricing statistics, advertising demand data, and projected advertising revenue.
